(19) United States
(12) Patent Application Publication
(10) Pub. No.: US 2017/0267019 A1
(43) Pub. Date: Sep. 21, 2017

(54) Modular Palette Grip with Tablet Module

(71) Applicant: Aaron Thomas Dirkman, Milwaukee, WI (US)

(72) Inventor: Aaron Thomas Dirkman, Milwaukee, WI (US)

(21) Appl. No.: 15/413,344

(22) Filed: Jan. 23, 2017

Related U.S. Application Data
(60) Provisional application No. 62/242,277, filed on Jan. 20, 2016.

(51) Int. Cl. B44D 3/02

(52) U.S. Cl. CPC B44D 3/02

(57) ABSTRACT

A hand held modular artist palette, which is comprised of plurality of handles and a plurality of tablet modules attached together via fasteners. The problems with prior inventions are that they are uncomfortable to hold and give left and right hand users very few features that improve the use, fit, and function of the palette. This invention improves prior art by providing left and right hand users a controlled universal comfortable fit, varying size mixing surfaces, a place to portion or store paint, and the ability to mix paint on different toned surfaces form varying materials all with one handle. Handles can also differ in size, shape, and function. The handles and tablets can be manufactured from a variety of woods, plastics, glass, etc. to further provide the user longer lasting, higher quality alternative options that make cleaning and mixing more efficient.

### BACKGROUND OF INVENTION

Artists of different disciplines need tools to mix, hold, measure, proportion and store a variety of resources including oil paint, acrylic paint, dye, ink, and other mediums. They may use palettes, containers, lids, and covers intended to be used for this purpose, or may choose to use recycled materials that come from other products to accomplish the same goal. Many artists purchase a traditional artist's palette, usually oval or square in shape with a hole for the thumb that allows the artist to hold a flat surface so they can control a volume of paint and mix a variety of colors or mediums on it. Traditional palettes can be uncomfortable to use when held for long periods of time and offer very few additional or alternative features to the artist. Artists need palettes that vary in size and material depending on the size of the painting or the different paints that are being used. Some artists use palettes made from wood, plastic, or glass of varying tones to mix paint on. The fact that paint is sometimes translucent and appears to look different depending on the color of background upon which it is mixed creates a need for specific mixing surfaces. The artist's modular palette was designed with several different features that improve the fit, feel, flexibility, control, use, comfort, and utility of the tool over any current or past designs that function as a palette.

### BRIEF SUMMARY OF THE INVENTION

The artist's modular palette is a two-piece modular painter's palette composed of a multi-functional paint proportioning/storage handle (grip) that attaches via fasteners to a variety of paint mixing tablet modules which serve as interchangeable palettes. The ergonomically contoured grip also serves as a paint proportioning, mixing, and storage area. The uniquely profiled tablet surfaces are available in varying sizes, materials, tones, and shapes.

The invention is described in two embodiments determined by the joint connecting the grip to the tablet. Two embodiments are necessary to meet variances in material properties, production methods, consumer, and market needs. One embodiment, the grip (currently constructed of wood), utilizes a rebate and lip and adjoins the face by fasteners. The top face of the grip has plunged bowls and the bottom of the grip is left flat creating a left grip handle. This embodiment serves as a right grip handle when the design is mirrored. The second embodiment of the grip (ideally constructed of plastic) utilizes a tongue and groove joint that adjoins the tablet module. In the second embodiment, the top face and bottom face of the grip are mirror images of each other, having bowls on both the top face and bottom face of the handle, which when inserted and fastened to the tablet module create a palette that can be used by either a left handed or right handed artist. The second embodiment can be referred to as having a universal fit.

The artist's modular palette solves a number of problems present in prior art, and present in both current and historic designs of traditional artist's palettes. Traditional palettes are thin, creating an edge surface area; artists may hold a palette for hours and the pressure of a thin edge against the skin can cause pain, sore spots, irritation, and discomfort. The artist's modular palette utilizes the thickness of the grip along with the top and bottom face edges being shaped as fillet, increasing the surface area that contacts the skin, to alleviate discomfort. The added thickness of the grip not only alleviates discomfort, but it also adds weight to the upper right hand corner of the palette offsetting the weight of the tablet module, which solves a second problem by providing a more balanced feel than traditional palettes.

The artist's modular palette further adds new additional features and flexibility to the traditional painter's palette design. One such feature are the plunged bowls on the grip, which not only hold a volume of paint or other liquids to prevent spillage, but allow the arrangement of the bowls to be used to visualize a proportioning system. Ratios of different color of paint or other mediums can be measured using the bowls as references to the size and amounts of colors and mediums being mixed. Another feature that improves upon past palette designs is the interchangeability of varying size tablets that can be attached and used with either embodiment of the grip. An additional feature of the modular painter's palette is the ability to rotate the handle and tablet module 360 degrees about the thumb by using the second grip to hold on to. This gives the artist three alternate hand placement-positioning options. Grip one offers a more traditional horizontal approach, Grip two offers a vertical approach, and position three is an open approach away from the body with the fingers spread underneath the face rather than clenching either grip.

### BRIEF DESCRIPTION OF DRAWINGS

FIG. 1 is an isometric drawing of a palette from the top face looking down at a handle with grooves (mortises) cut into both grips, next to a tablet module as the tongue (tenons), which when inserted and secured with fasteners encompasses embodiment 1 of the invention.

FIG. 2 is an isometric drawing of the palette from the top face looking down at a handle with a rebate cut into the grips, and a tablet module as the lip, which when attached via fasteners encompasses embodiment 2 of the invention. An optional cover that fits over the handle is shown to describe how accessories could be included.

FIG. 3 is a top plan view showing the symmetric nature of the grip design. This view is intended to demonstrate the grip can serve as a left hand grip, a right hand grip, or both when designed as a universal grip (which has the top as a mirror image of the bottom when flipped over).

FIG. 4 is an isometric view of a left handle grip. The connection to the tablet module uses a rebate cut and the tablet module serves as the lip that can be set on top of the rebate to make a joint that's secured using fasteners as the fastening mechanism.

FIG. 5 is a cross-sectional view of a left handle grip and shows that the paint proportioning plunged bowls are on the top face and the joint is a rebate and lip joint.

FIG. 6 is a top plane view of a right grip handle. The solid line represents the back edge of the rebate that the tablet module or lip adjoins to it.

FIG. 7 is an isometric view of a universal handle grip in the left hand grip position. The view shows the handles joint that adjoins the tablet module as a tongue and groove joint. It can be described as the female or receiving end and can be secured to the tablet module using a fastening mechanism.

FIG. 8 is a cross-sectional view of a universal grip and shows the paint proportioning and mixing bowls are on both the top face and bottom face of the modular handle. This view describes in more detail the female or receiving end of the handle.

FIG. 9 is a top plane view of a universal handle grip in the right grip position. The dashed line represents the back of the rebate that makes up the receiving end of the handle.

FIG. 10 is a top plan view of the left and right grip profile according to one embodiment of the invention.

FIG. 11 is a an isometric drawing of three varying toned tablet modules, one on top of the other, demonstrating the left handle grip could attach and accommodate different palette modules of different materials (wood, plastic, glass, etc.), textures, colors, or surface finishes.

FIG. 12 is a top plan view of the original tablet module profile with dimensions.

FIG. 13 is a top plan view of an alternative tablet module profile with a smaller paint mixing surface area, which makes it lighter, and more compact for smaller projects.

FIG. 14 is a top plan view of yet a third alternative tablet module with a larger surface area to accommodate larger volumes of paint customary for larger projects.

### DETAILED DESCRIPTION OF THE INVENTION

This particularly advantageous invention can be described in two embodiments of a handle, grips, and varying sized tablet modules that can be attached to either handle by use of fasteners.

The first embodiment of the handle is illustrated by the isometric drawing on page 1/4 FIG. 2, and is the original or base concept for the invention. This embodiment, currently made from wood, utilizes a ½″ thick handle with a ¼″ rebate on each grip of the handle. Each grip has one 11/64″ hole drilled through each rebate of the handle along with a ½″ diameter countersink on the bottom of the handle. A ¼″ thick tablet module, the lip, has two holes drilled through it, that align with the holes drilled in the handle. The tablet module sits on top of the rebate creating two joints that are fastened by two fasteners. The handle in this embodiment has plunged paint wells on only the top face of the handle, as described on page 2/4 by FIG. 4. This embodiment serves the user as either a left hand grip for right hand artists, or right hand grip for left hand artists. In this embodiment of the invention two separate handles are needed to accommodate different users.

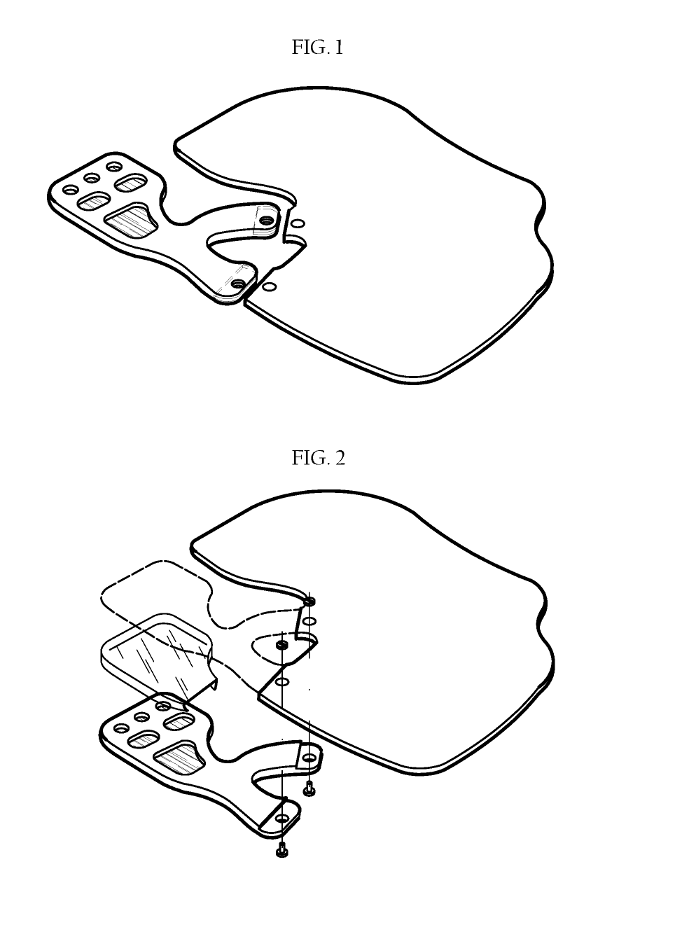

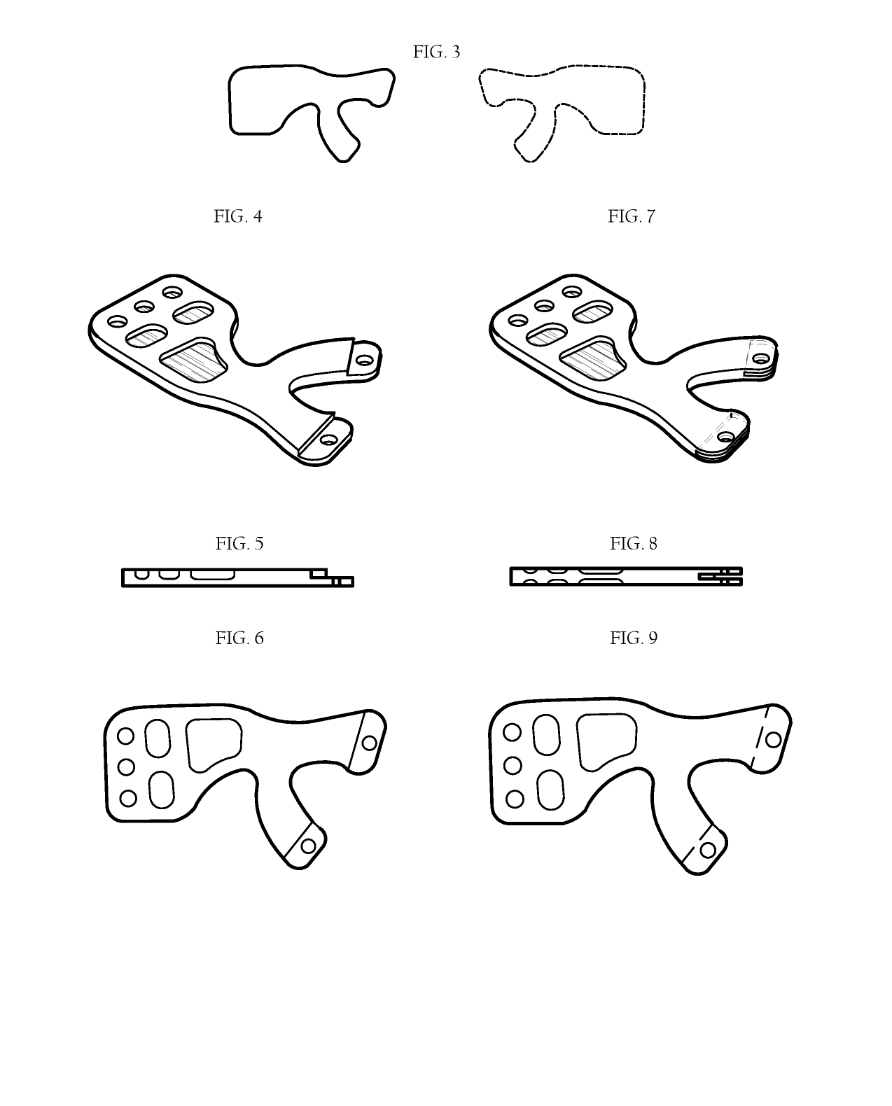

The second embodiment of the modular handle grips is illustrated on page 1/4 FIG. 1 and is a variation of the first embodiment, but utilizes a tongue and groove joint to adjoin the handle grips to the tablet module. This is accomplished with a handle that is ⅝″ thick, preferably made from plastic and has paint wells on both the top face and bottom face of the handle as seen on page 2/4 in FIG. 8. The handle's two grips each have an 11/64″ hole drilled through the sleeves of the groove. The same tablet module that is used in embodiment 1 can serve as the tongue, so that when inserted into the groove (mortise) the two adjoin and are secured by fasteners. This embodiment is the universal fit design that can serve both left hand and right hand users with the same handle.

In each embodiment of the invention the tablet module is interchangeable and can be used regardless of which handle or which joint is being used. FIG. 7 describes the symmetric nature of the two embodiments of the invention and in the left image the top face is the top when held in the left position grip. When flipped upside down the bottom face of the tablet module becomes the top when held in the right grip position. Each face has two 11/64″ through holes drilled and ½″ diameter countersink on both the top face and bottom face of the tablet module to accommodate an interchangeable feature within the embodiment of the invention.

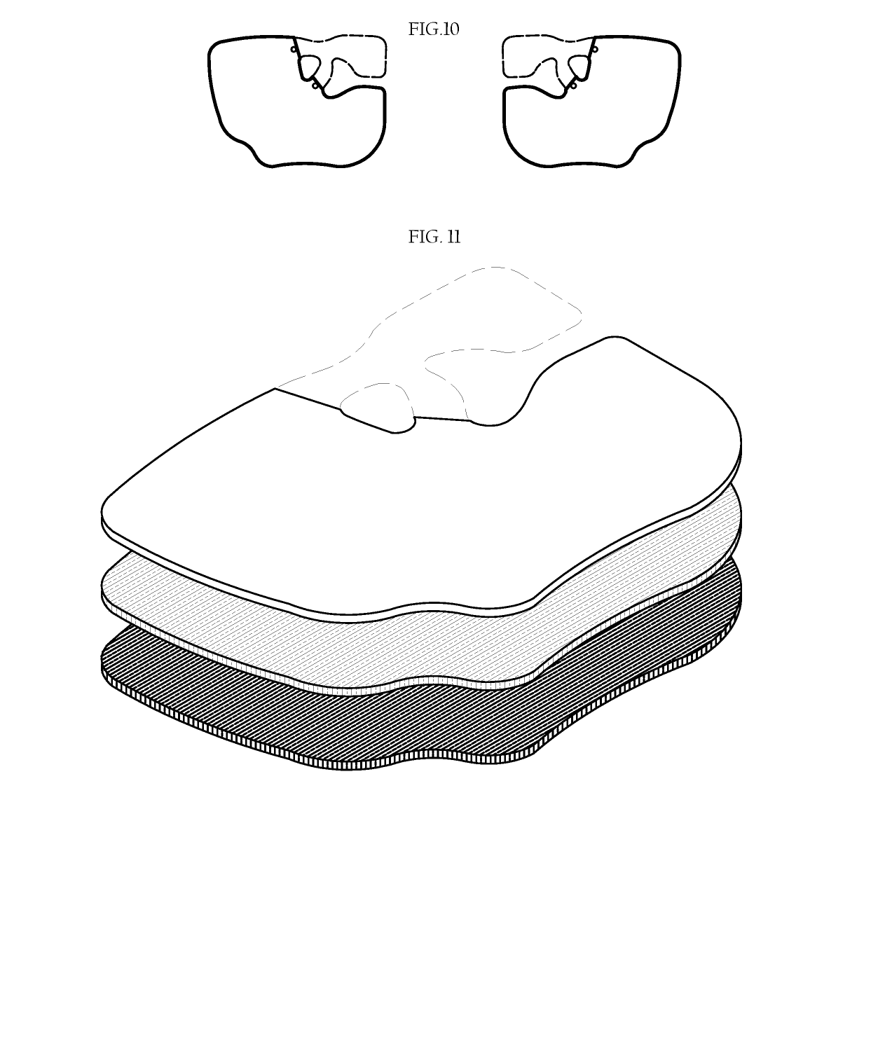

FIG. 10 on page 3/4 is an isometric view of three tablet modules of varying tones that represent varying materials such as wood, colored wood, or plastic, that offers the user an interchangeable feature to the modular painters palette. Wood or plastic tablet modules are used to accomplish this feature. Plastic tablet modules can be made from a variety of colors: clear, white, mid-tone, or black to provide artists a mixing surface that matches the tone of the painting they're working on, while still retaining the properties of mixing on plastic. Wood tablet modules can be toned with a variety of products: stain, dyes, coloring, oil, pigments or varying types of wood can be used (ex. maple, walnut, etc.) to provide the user the ability to mix paint on a wood surface that matches the tone of the painting they're working on. Wood tablet modules and handles can be coated with various finishes, if desired, to protect the wood, ease the process of cleaning, and extend the life time of the palette.

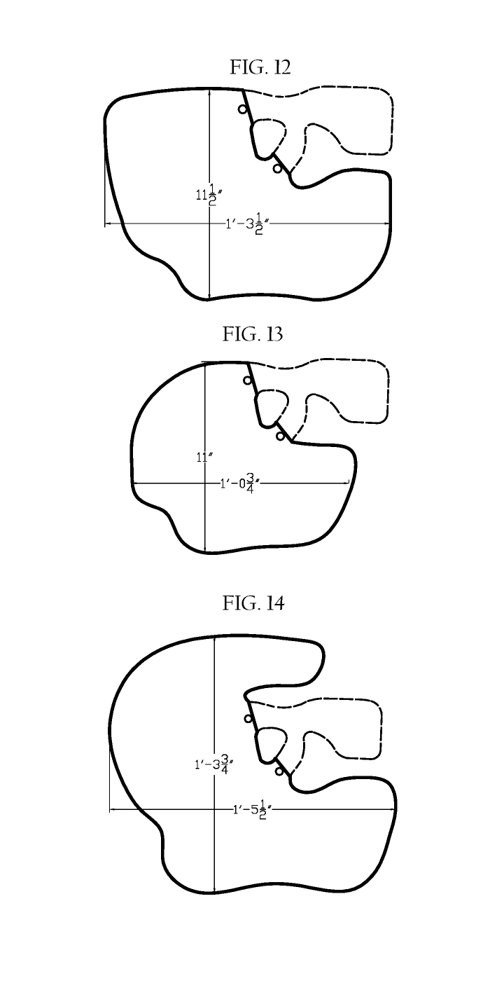

FIGS. 11, 12, and 13 on page 4/4 are alternatively sized and shaped mixing surfaces denoted as tablet modules. The tablet modules in this embodiment of the invention are a ¼″ thick and have edges shaped as a fillet that seat comfortably around the thumb, against the users arm, or up against the user's body. FIG. 11 is the original design and its outer edge is contoured specifically to allow the user to rotate the palette 360 degrees about the thumb and comfortably seat against the body. This is accomplished by using both grips: the vertical grip to hold the palette in a horizontal position or the horizontal grip to hold the palette in a vertical position. FIGS. 4-9 all show both grips can be held on to by the user. The thumb contours of the handle combine with the face's edge contours, giving the artist a variety of palette positioning options dependent on which grip they hold that changes the palettes orientation to the canvas. FIG. 12 is a smaller design with a smaller surface area for users working on smaller projects that prefer something lighter in weight. FIG. 13 is a larger surface area design and includes the same features as FIG. 11; however serves to function as a larger surface area design to give the user a larger mixing area for larger projects.

In the above description, including both embodiment one and embodiment two, as illustrated in the drawings, the drawings are only illustrative of the two existing embodiments. However, changes may be made to the specific dimensions, size, appearance, mechanism for fastening, construction, method of adjoining modules as illustrated and described within the scope of the appended claims.

With respect to the above description then, it should be realized that the optimum dimensional relationships for the parts of the invention, to include variations in size, materials, shape, form, function and manner of operation, assembly and use, are deemed readily apparent and obvious to one skilled in its use, and all equivalent relationships to those illustrated in the drawings and described above are intended to be encompassed by the present invention.

Therefore, the foregoing is considered as illustrative only of the principles of the invention. Since numerous modifications and changes will be sought after with respect to size, shape, material and fastening connection for both the grips and the tablet modules, it is not desired to limit the invention to the exact construction and operation shown and described, and accordingly, all suitable modifications and equivalents may be resorted to, falling within the scope of the invention.

1. A Modular Palette Handle Grip comprising:
a modular handle grip having, a top face, a bottom face, a front, and a back adapted to receive a tablet module being selected from a plurality of tablet modules; and
a tablet module having a top face, a bottom face, a front, and a back; and
a fastening mechanism to attach said tablet module to said modular handle grip;
wherein front of a said tablet module is attached to back of said modular handle grip via said fastening mechanism, so as to be interchangeable with alternative tablet modules.

2. The invention of claim 1 wherein the method for adjoining said handle grip to tablet comprises:
(a) a handle grip comprising of a rebate with said tablet comprising of a lip, wherein adjoining them so that the lip overlaps the rebate, and
(b) said handle grip is attached to said tablet module by insertion of fasteners through the rebate of said handle and through lip of said tablet module.

3. The invention of claim 1 wherein the method for adjoining said modular handle grip to tablet module comprises:
(a) a handle grip comprising of a groove (mortise) with said tablet module comprising of a tongue (tenon), wherein adjoining them so that the tongue (tenon) is inserted into said groove(mortise), and
(b) said handle grip is attached to said tablet module by insertion of fasteners through back of groove on said handle, through the tongue of said tablet module, through front of groove in said handle grip.

4. The invention of claim 1 further comprising an array of bowls on the top face of said handle grip wherein the array of bowls are arranged to proportion, contain, hold, store and measure.

5. The invention of claim 1 further comprising an array of bowls on the top face of said handle grip and bottom face of said handle grip, wherein the array of bowls is arranged to proportion, contain, hold, store and measure.

6. The invention of claim 1 further comprising of a secondary handle for alternate holding positions.

7. The invention of claim 1 wherein the said handle's grip and tablet's bottom face edges and top face edges are a fillet.
